(19) United States
(12) Patent Application Publication
(10) Pub. No.: US 2013/0149214 A1
(43) Pub. Date: Jun. 13, 2013

(54) MICROVASCULAR FLUIDIC DEVICES, SYSTEMS AND METHODS RELATED THERETO

(71) Applicants: Emory University, Atlanta, GA (US); Children's Healthcare of Atlanta, Inc., Atlanta, GA (US); Georgia Tech Research Corporation, Atlanta, GA (US)

(72) Inventors: Wilbur A. Lam, Decatur, GA (US); Michelle Tsai, San Mateo, CA (US); Ashley Kita, Los Angeles, CA (US); David R. Myers, Atlanta, GA (US); Yumiko Sakurai, Atlanta, GA (US); Byungwook Ahn, Atlanta, GA (US); Yongzhi Qiu, Atlanta, GA (US); Gang Bao, Atlanta, GA (US)

(73) Assignees: EMORY UNIVERSITY, Atlanta, GA (US); GEORGIA TECH RESEARCH CORPORATION, Atlanta, GA (US); CHILDREN'S HEALTHCARE OF ATLANTA, INC., Atlanta, GA (US)

(21) Appl. No.: 13/710,707

(22) Filed: Dec. 11, 2012

Related U.S. Application Data
(60) Provisional application No. 61/569,498, filed on Dec. 12, 2011.

(51) Int. Cl. B01L 3/00

(52) U.S. Cl. CPC B01L 3/5027
USPC 422/502

(57) ABSTRACT

Microfluidic devices and processes are provided that relate to microvascular-sized systems configured to identify specific pathophysiological characteristics related to the interactions between, for example, blood cells and endothelial cells combined with geometric and flow constraints of microvasculature. The device may include at least one layer, the layer including a plurality of microvascularized-sized fluidic channels, the plurality of microfluidic channels being disposed in a geometric pattern. The layer may be composed of a hydrogel and/or a silicon elastomer. The channels may include subchannels of different lengths.

### CROSS REFERENCE TO RELATED APPLICATION

This application claims priority to U.S. Provisional Application Ser. No. 61/569,498 filed on Dec. 12, 2011, which is hereby incorporated by this reference in its entirety.

### ACKNOWLEDGEMENTS

This invention was made with government support under Grants HL093360 awarded by the National Institutes of Health. The government has certain rights in the invention.

### BACKGROUND

Hematologic diseases often involve pathological biophysical interactions among blood cells, endothelial cells, and soluble factors (e.g., cytokines, coagulation factors, etc.) that lead to microvascular occlusion and thrombosis, such as in sickle cell disease (SCD) and thrombotic microangiopathies. See, e.g., Ballas S K, Mohandas N. Sickle red cell microrheology and sickle blood rheology. Microcirculation. 2004; 11(2):209-225; Bunn H F. Pathogenesis and treatment of sickle cell disease. N Engl J Med. 1997; 337(11):762-769; and Moake J L. Thrombotic microangiopathies. N Engl J Med. 2002; 347(8):589-600. Alterations in the biophysical properties, such as cell adhesion, cell aggregation, and cell deformability, of blood cells contribute to the pathophysiology of these disease states, ultimately leading to compromise of microvascular flow in vital organs. See, e.g., Lipowsky H H. Microvascular rheology and hemodynamics. Microcirculation. 2005; 12(1):5-15; and Barabino G A, Platt M O, Kaul D K. Sickle cell biomechanics. Annu Rev Biomed Eng. 2010; 12:345-367. Although animal models have vastly improved our understanding of these diseases, complementary in vitro systems have the potential to offer valuable quantitative insights into how biophysical properties influence pathophysiology.

Most biophysical studies have primarily employed in vitro methods that focus on a singular, isolated aspect of microvascular occlusion and thrombosis. For example, techniques that quantify cell deformability, such as micropipette aspiration and atomic force microscopy, have been broadly applied. See, e.g., Bao G, Suresh S. Cell and molecular mechanics of biological materials. Nat Mater. 2003; 2(11):715-725. Similarly, parallel plate flow chambers have been used extensively to study the adhesion dynamics between blood cells and cultured endothelial cell monolayers and have led to important advances in our understanding of vascular and hematologic pathology. See, e.g., Kaul D K, Finnegan E, Barabino G A. Sickle red cell-endothelium interactions. Microcirculation. 2009; 16(1):97-111. Furthermore, aggregation assays have extended to clinical use to study platelet function. See, e.g., Mezzano D, Quiroga T, Pereira J. The level of laboratory testing required for diagnosis or exclusion of a platelet function disorder using platelet aggregation and secretion assays. Semin Thromb Hemost. 2009; 35(2):242-254. However, there are no currently existing vitro assays that effectively integrate these pathological processes within a single system to enable the quantitative investigation of microvascular occlusion in hematologic diseases, as well as clotting and bleeding.

In the past decade, there have been advances in microfabrication technologies that have provided useful, inexpensive, and easily reproducible microfluidic platforms for conducting microscale biological and biochemical experiments. See, e.g., Young E W, Beebe D J. Fundamentals of microfluidic cell culture in controlled microenvironments. Chem Soc Rev. 2010; 39(3):1036-1048; and Young E W, Simmons C A. Macro- and microscale fluid flow systems for endothelial cell biology. Lab Chip. 2010; 10(2):143-160. The ability to easily and tightly control biological conditions and the dynamic fluidic environment within the system enable microfluidics to be ideal tools for quantitatively analyzing hematologic and microvascular processes. See, e.g., Higgins J M, Eddington D T, Bhatia S N, Mahadevan L. Sickle cell vasoocclusion and rescue in a microfluidic device. Proc Natl Acad Sci U S A. 2007; 104(51):20496-20500; Rosano J M, et al. A physiologically realistic in vitro model of microvascular networks. Biomed Microdevices. 2009; 11(5):1051-1057; and Kotz K T, et al. Clinical microfluidics for neutrophil genomics and proteomics. Nat Med. 2010; 16(9):1042-1047. Accordingly, researchers have recently applied microfluidic devices to study blood cell deformability, blood flow, and blood-endothelial cell interactions. See, e.g., Rosenbluth M J, Lam W A, Fletcher D A. Analyzing cell mechanics in hematologic diseases with microfluidic biophysical flow cytometry. Lab Chip. 2008; 8(7):1062-1070; . Shelby J P, White J, Ganesan K, Rathod P K, Chiu D T. A microfluidic model for single-cell capillary obstruction by Plasmodium falciparum-infected erythrocytes. Proc Natl Acad Sci U S A. 2003; 100(25):14618-14622; Borenstein J T, et al. Functional endothelialized microvascular networks with circular cross-sections in a tissue culture substrate. Biomed Microdevices. 2010; 12(1):71-79; and Nesbitt W S, et al. A shear gradient-dependent platelet aggregation mechanism drives thrombus formation. Nat Med. 2009; 15(6):665-673.

There have been reports describing successful cross-sectional coverage of endothelial cells in microfluidic systems. See, e.g., Fiddes L K, et al. A circular cross-section PDMS microfluidics system for replication of cardiovascular flow conditions. Biomaterials. 2010; 31(13):3459-3464; and Lee S H, Kang do H, Kim H N, Suh K Y. Use of directly molded poly(methyl methacrylate) channels for microfluidic applications. Lab Chip. 2010; 10(23):3300-3306. However, these devices are larger than the microvascular size scale relevant to the pathologic processes at that anatomic level.

Therefore, a system that can accurately recapitulate the cellular, physical, and hemodynamic environment of the microcirculation is needed to improve our understanding of microvascular diseases, as well as clotting and bleeding.

### SUMMARY

The disclosure relates to microfluidic devices and processes for providing microvascular-sized systems that can be configured to identify specific pathophysiological characteristics related to the interactions between, for example, blood cells and endothelial cells combined with geometric and flow constraints of microvasculature.

In some embodiments, the disclosure relates to a device that includes a layer, the layer including a plurality of microvascularized-sized fluidic channels, the plurality of microfluidic channels being disposed in a geometric pattern; and the layer being composed of the hydrogel.

In other embodiments, the disclosure relates to a device that includes a plurality of layers. In some embodiments one of the layers may include at least a first set of at least one microfluidic channel and a second set of at least one microfluidic channel, the first set being configured to have a shear rate that is higher than a shear rate of the second set; and at least a first subchannel and a second subchannel, the first channel communicating with the first set and the second subchannel communicating with the second set, wherein the first subchannel has a length that is shorter than a length of the second subchannel. In some embodiments, the layer may be composed of hydrogel. In other embodiments, the layer may be composed of a silicon material.

### DESCRIPTION OF THE DRAWINGS

The disclosure can be better understood with the reference to the following drawings and description. The components in the figures are not necessarily to scale, emphasis being placed upon illustrating the principles of the disclosure.

FIG. 1 illustrates a layer of a microfluidic device that includes a geometric pattern of microfluidic channels;

FIG. 2 is an example of a prototype of a micropatterned fabricated silicon master cast in a silicone elastomer;

FIG. 3 show brightfield images show that within 48 hours, HUVECs seeded into the microdevice are cultured to confluency. Images are taken from different areas of the same device at the same scale. Scale bars: 30 μm;

FIG. 4 show 3D renderings of multiple confocal microscopy using fluorescent cell membrane (red) and cell nuclear (blue) dyes show that the endothelial cells line the entire inner surface of the microfluidic channels. The cross-sectional view also reveals that the cells round off the square corners of the smallest microchannels. Scale bars: 30 μm;

FIGS. 5A and B show an exploded and side view of a microfluidic device according to embodiments;

FIGS. 6A through C show images of an endothelialized hydrogel-based microfluidic device after 3 day culture under flow; and

FIGS. 7A and B show a device configured for variable shear rates according to embodiments.

### DESCRIPTION OF THE EMBODIMENTS

The following description, numerous specific details are set forth such as examples of specific components, devices, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications.

In some embodiments, the disclosure relates to a microvascular-sized fluidic (also referred to as microfluidic) devices, systems, and methods. In some embodiments, the methods relate to a simple, single-mask microfabrication process that can be combined with standard endothelial cell culture techniques to fabricate a microvascular-sized fluidic system that can incorporate a confluently cultured endothelial cell monolayer that covers the entire 3D inner surface of the microfluidic system. The system can be configured to fully integrate blood-endothelial cell adhesion, cellular aggregation, cellular mechanical properties (i.e., size, deformability, etc.), microvascular geometry, and hemodynamics and can therefore be suitable for quantitative biophysical analyses of diseases involving microvascular occlusion and thrombosis. The systems can be used, for example, to study hematologic diseases with pathologies that span the fields of both biology and biophysics, such as sepsis/inflammatory disorders, SCD, thrombotic microangiopathies, among others. The systems can also be configured, for example, to recapitulate physiological processes, including platelet, leukocyte, and endothelial activation, adhesion molecule expression, cell aggregation, cytokine production, and interactions among these many different cell types as well as biophysical and rheological interactions among hemodynamics, microvascular geometry, and multiple cell types.

In some embodiments, the microfluidic system can be configured to identify specific pathophysiological characteristics related to the interactions between blood cells and endothelial cells combined with geometric and flow constraints of microvasculature. For example, the system can be capable to demonstrate: (a) in the context of inflammation, TNF-α activation of both leukocytes and endothelial cells leads to a much higher rate of microchannel obstruction than activation of endothelial cells alone, (b) the multiple effects of hydroxyurea lead to an overall increase in microvascular flow using sickle cell blood, and (c) with shiga toxin (STX) activation, the microsystem functions as an in vitro model of hemolytic uremic syndrome (HUS), a thrombotic microangiopathy. The microsystems can be capable to capture specific biophysical interactions involved in these and other diseases. In some embodiments, the microsystems can be used as a drug discovery platform, for example, for hematologic diseases involving the microvasculature.

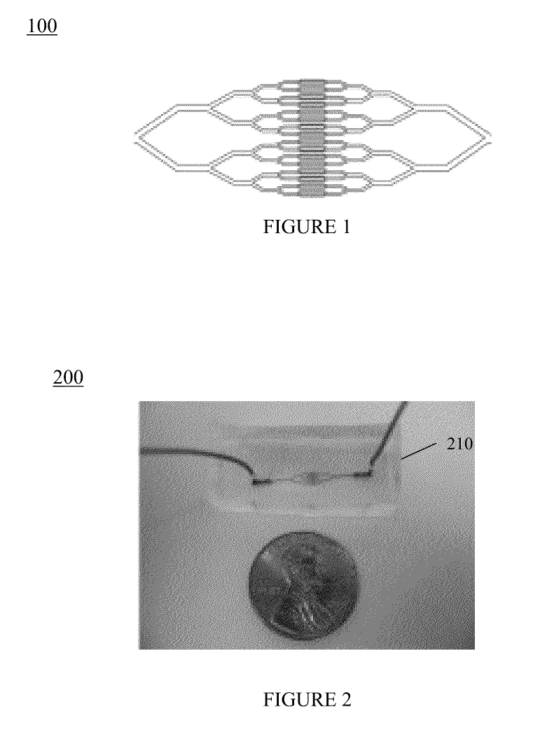

In some embodiments, a microfluidic device may include at least one layer. The microfluidic device may include a plurality of microvascular-sized fluidic channels. The plurality of microvascular-sized fluidic channels may have a geometric pattern. The pattern may be configured to simulate the microvasculature of the human body. FIG. 1 shows a pattern of microfluidic channels 100. The device may have a different geometric pattern.

In some embodiments, the dimensions of the microchannels may approximate the anatomy of postcapillary venules in humans. In some embodiments, the channels may have varying width. In some embodiments, the smallest channel may have the dimensions of about 30×30 um. The ratio of total channel surface area to total daughter channel surface area (e.g., total surface area of smaller branches that arise from a larger “mother” channel) may be 1:1.4. In some embodiments, the channels may have square cross sections. The channels may be configured so that the lining of endothelial cells on the channels' inner walls round out the sharp edges and thus can result in more circular, and therefore more physiologic, cross-sections.

In some embodiments, the devices may be fabricated by a single-mask photolithography process. The micropatterned fabricated silicon master may function as a mold, and the microchannels may be casted in a silicone elastomer, for example, polydimethylsiloxane (PDMS). An example 200 of an elastomer 210 is shown in FIG. 2. This process can allow multiple, identical, and disposable microfluidic devices to be made from the same master and enable the process to be reproducible and inexpensive.

In some embodiments, the process of fabricating the devices may include the following steps. First, the method may include transferring the geometric pattern of the microfluidic channels onto a mask via laser photoplotting. Next, the method may include patterning the channels onto 6″ silicon wafers using, e.g., SU-8 photoresist (MicroChem, Inc.). The method may include steps of subsequent UV exposure, post-baking, and developing steps, for example, per the manufacturer's specifications. The patterned wafers may then be treated with (tridecafluoro-1,1,2,2-tetrahydrooctyl) trichlorosilane (Gelest) to prevent permanent adhesion of the device material, polydimethylsiloxane (PDMS). PDMS, mixed at a 10:1 ratio (w/w) of polymer to curing agent, may then be poured onto the silicon wafers and cured at 60° C. for about 24 h. The cured PDMS device may then be excised and holes for the inlet, outlet, and bypass may be formed using a 1.5 mm hole puncher. The complementing bottom portion of the device may be created by pouring a thin layer of PDMS (approximately 1 mm in thickness) onto a standard disposable petri dish, curing the PDMS under the same conditions as above, and cutting out a rectangular piece large enough to encompass the surface area of the top portion of the device. Once the top and bottom portions of the device are removed from their respective molds, any foreign particles may be removed from their surfaces, for example, with transparent tape. Both portions may then be placed in a beaker filled with 100% ethanol and sonicated for 10-15 minutes. After rinsing the surfaces thoroughly with DI water, the two pieces may be placed with bonding sides facing up, onto a clean petri dish, then air dried at 60° C. in the oven. Finally, after the PDMS is cleaned and dried, the top and bottom potions may be bonded together, for example, using 15 second exposure to oxygen plasma using an oxygen plasma cleaner (Plasmod).

In some embodiments, the disclosure may relate to a process to create or fabricate systems of 3D microvascular-sized fluidic channels that are completely lined with endothelial cell monolayers. In some embodiments, the method of creating systems of 3D microvascular-sized fluidic channels that are completely lined with endothelial cell monolayers may include seeding the microfluidic chips with human endothelial cells. In preparation for cell seeding, the top and bottom portions of the device may be bonded via exposure to oxygen plasma (Plasmod) and the channels coated with 50 μg/ml fibronectin from human plasma (Sigma-Aldrich), incubating at 37° C., 5% CO₂ for 45-60 minutes. The channels may then be rinsed with PBS. Cells may be prepared, for example, at 500,000-3,000,000 cells/ml medium with 8% mass/volume dextran 500 (Sigma-Aldrich) and infused into the device at 1.25 μl/min for 2 hours with a delivery device, such as syringe pump. Dextran can increase the viscosity of the cell-seeding medium and decrease the velocity of endothelial cells as they enter the microfluidic system, which in turn increases the likelihood that the cells will adhere and culture. Next, the method may include exposing the cells to a constant flow of culture medium at a substantially the same rate within the microfluidic system. This can result in the development of confluent monolayers within 24 to 48 hours.

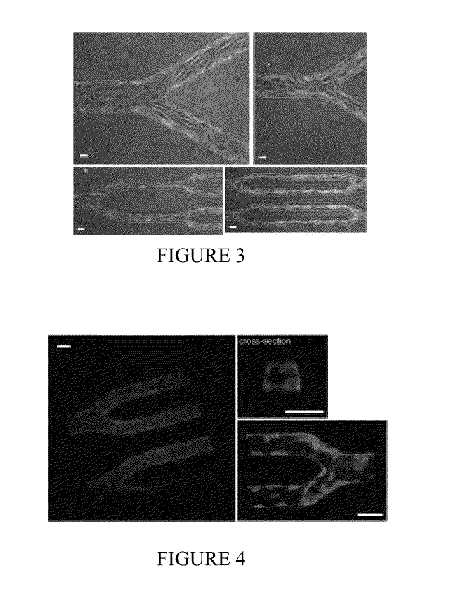

FIG. 3 shows brightfield microscopy images of different areas of the same network in the same device in which HUVECs successfully seed the entire microfluidic system within 36 hours. Live cell confocal imaging using fluorescent cell membrane and cell nuclei dyes (see Methods) revealed that HUVECs appeared to successfully culture the entire 3D inner surface of the microfluidic system to confluence (FIG. 4). The presence of endothelial cells can decrease the effective lumen size to a range of 24 to 28 μm in width/height for the smallest microchannels, and their cell bodies yielded a more rounded cross-section of the microchannels (FIG. 4), enabling conditions to be more physiologic. This process can also be used with other human endothelial cells, including those of microvascular origin, such as human lung microvascular endothelial cells (HLMVECs 1) and human microvascular endothelial cell line 1 (HMEC-1).

In some embodiments, the devices may be made of a hydrogel material. Because the gels can be collagen based, the devices may be more physiologic and similar to human tissue. In some embodiments, the devices according to embodiments may be configured for therapeutic use. For example, the devices may be configured for implantation into patients after mini-blood vessels are grown. The devices, for example, may be used for and not limited to venous grafts for cardiac bypass surgery, as well as other therapeutic uses.

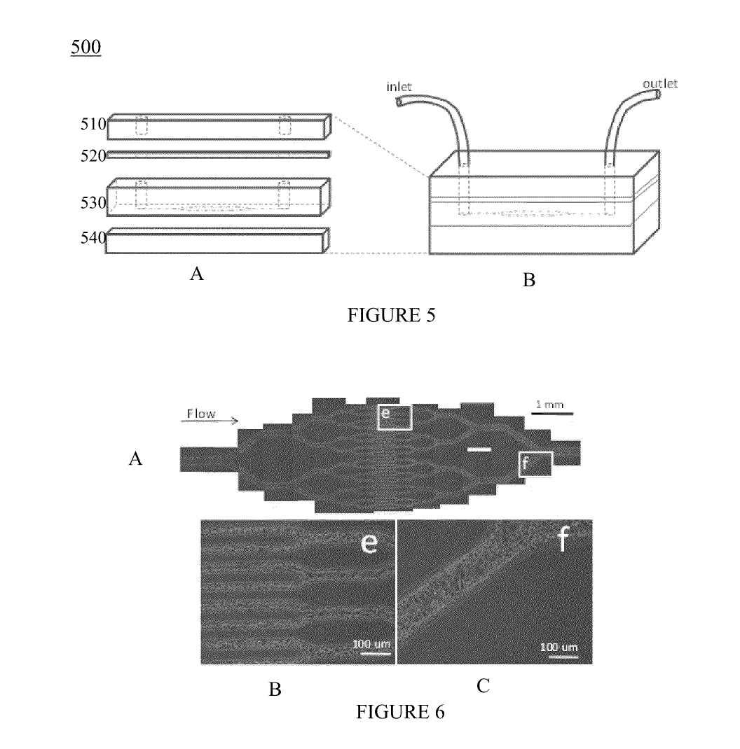

FIGS. 5A and 5B show a device according to embodiments. FIG. 5A show an exploded view of the device 500 shown in FIG. 5B. In some embodiments, the device 500 may include more than one layer. The device 500 may include at least one hydrogel layer. In some embodiments, the device 500 may include at least two hydrogel layers.

In some embodiments, the device 500 may include a first layer 510. The first layer 510 may be a PDMS (silanized with amine groups on the surface). In some embodiments, the device 500 may include a second layer 520. The second layer 520 may be a gelatin layer. In some embodiments, the device 500 may include third and fourth layers 530 and 540. The third and fourth layers 530 and 540 may each be a hydrogel layer. The fourth layer 540 may be the base layer. The hydrogel layers may include a mixture of agarose and gelatin. In some embodiments, one of the layers may include a plurality of microchannels. In some embodiments, the third layer 530 may include the plurality of microchannels. In some embodiments, the microchannels may have a geometric pattern as shown in FIG. 1.

In some embodiments, the covalent binding of different layers may be achieved by immersing the 4 tightly-contacting layers into 0.25% glutaraldehyde aqueous solution or EDC/NHS solution for overnight. In some embodiments, the method to fabricate the hydrogel-based microfluidic device may include covalently bounding the layer 510 (PDMS layer) to the top surface of the one of the hydrogel layers. PDMS may first be plasma treated and silanized by incubating with 10% aminopropyltrimethoxysilane in 95% ethanol under 60° C. for 2 hrs. Therefore, the silanized PDMS may have amine groups on the surface.

Next, a mixture solution of gelatin and agarose may be made and casted on the mold (silicon wafer with features). After solidification under 4° C., the hydrogels may be removed from the mold to fabricate the layer 530. The mixture solution may also be casted on a flat silicon wafer to make the fourth layer 540.

In some embodiments, 8% gelatin solution may be solidified on the surface of silanized PDMS to form the layer 520. The hydrogel layer 530 may be put on the surface of layer 520, followed by punching the holes for inlet and outlet. Finally, the layer 540 may be put on the surface of layer 530.

In some embodiments, the whole device may then be immersed in 0.25% glutaraldehyde for overnight or in EDC/NHS solution for about 1 day. Afterwards, the device may then be washed, for example, with water, several times to remove the residue of glutaraldehyde or EDC/NHS.

FIGS. 6A through C show an example of an endothelialized hydrogel-based microfluidic device according to embodiments after 3 day culture under flow. FIGS. 6B and 6C are the magnified images of boxes E and F, respectively, in FIG. 6A.

In some embodiments, the devices may include endothelialized microfluidics with in vitro models of blood vessels that vary in size and flow rate (shear) within the same device. In some embodiments, the devices may be configured to have more than one shear rate when a constant shear rate is applied. This can enable the testing of different conditions simultaneously.

In some embodiments, the devices may be made of silicon. In other embodiments, the devices may be made of hydrogel, for example, as described with respect to FIGS. 5A-6C.

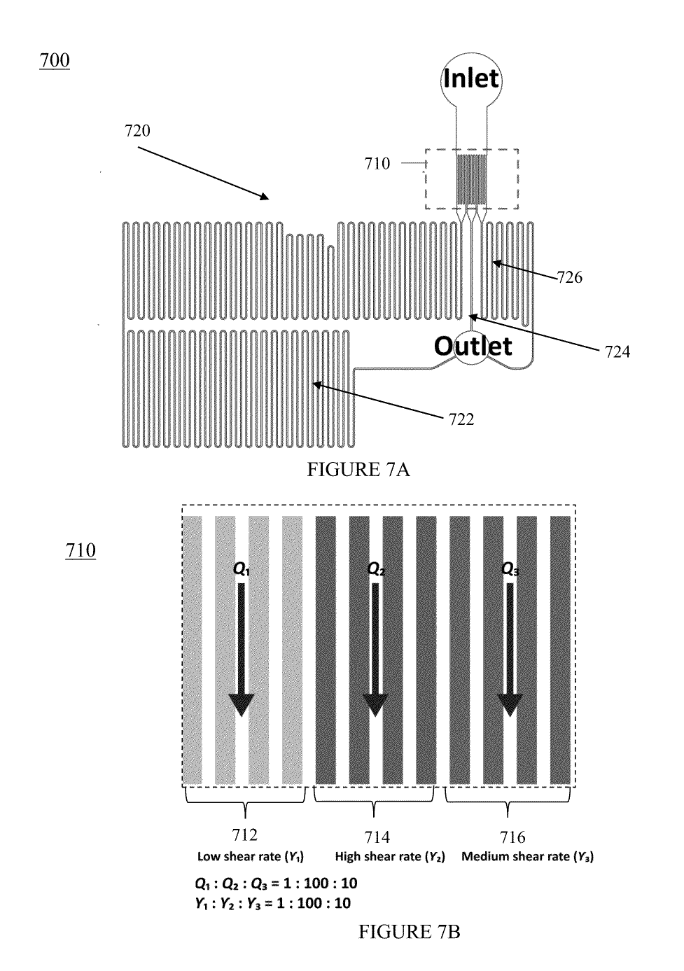

In some embodiments, the device may include more than one layer. The device may include a plurality of microfluidic channels disposed in at least one layer. FIGS. 7A and 7B illustrate an example a microfluidic device 700 that includes a plurality of microfluidic channels.

In some embodiments, the microfluidic device 700 may include at least one set 710 of at least one microfluidic channel. The microfluidic device 700 may include more than one set. In some embodiments, the microfluidic device 700 may include three sets of channels 712, 714, and 716, as shown in FIGS. 7A and 7B. In other embodiments, the device 700 may include any number of sets, for example, more or less sets. The sets of channels may be disposed after and communicate with an inlet.

In some embodiments, each set may include at least one channel. In other embodiments, each set may include a plurality of channels disposed in parallel. For example, each set may include four channels. In other embodiments, each set may include any number of channels, for example, more or less channels. In some embodiments, the channels of each set may merge into one subchannel.

In some embodiments, the channels 710 may have substantially the same dimensions, for example, length, width, and/or height. In other embodiments, the channels 710 may have different dimensions.

In some embodiments, the microfluidic device may be configured to have a different shear rate associated with each set of channels. In some embodiments, the device may be configured for three different shear rates. In some embodiments, the shear rates may correspond to, for example, a vein and/or artery. For example, the shear rates may include 10 fold differences in shear rates, such as 10 sec., 100 sec., and 1000 sec. In other embodiments, the device may be configured for any shear rate and/or any number of shear rates.

In some embodiments, the device may include at least one microfluidic resistance control subchannel (also referred to as “channel”) that is communication with the microfluidic channel(s) and the outlet. In some embodiments, the microfluidic resistance control channel may communicate with the merged channel for each set of microfluidic channels. In some embodiments, the device may include more than one microfluidic resistance control channel. In some embodiments, the number of the microfluidic resistance control channel may correspond to the number of sets of microfluidic channels.

In some embodiments, the dimensions (e.g., width, length, and/or height) of the microfluidic resistance control channels may vary to correspond to the different shear rates. In some embodiments, the dimensions of microfluidic resistance control channel may correspond to the desired shear rate for each set. In some embodiments, only one of the dimensions may vary. In some embodiments, the length of each microfluidic resistance control channel may be different and the width and height may be substantially the same. The longer the length of the microfluidic resistance control channel the greater the shear rate. For example, each microfluidic resistance control channel may have a width and a height of about 50 um (width)×50 um (height).

As shown in FIGS. 7A and 7B, the microfluidic resistance control channels may include channels 722, 724, and 726. These channels 722, 724, and 726 may communicate with channels 712, 714, and 716, respectively, and be disposed between the channels 712, 714, 716, respectively and the outlet. The channel 722 may have the longest length and therefore the set 712 may have a low shear rate. The channel 724 may have the shortest length and therefore the set 714 may have a high shear rate. The channel 726 may have a length between the lengths of channels 722 and 724, and therefore the set 716 may have a medium shear rate.

In some embodiments, the device may be configured to maintain the substantially same shear rate regardless of other channels because of the parallel arrangement of the microfluidic channels.

According to embodiments, the devices may be fabricated in one or more pieces that can then be assembled. In one embodiment, separate layers of the devices may contain channels, regions, and/or holding devices. Layers of a device may be bonded together by clamps, adhesives, heat, anodic bonding, or reactions between surface groups (e.g., wafer bonding). Alternatively, the microfluidic devices may be fabricated as a single piece, e.g., using stereolithography or other three-dimensional fabrication techniques.

The microfluidic devices according to embodiments may be part of a system. In some embodiments, the system may include at least one pressure source. The pressure source may be configured to employ positive and/or negative pressure. The pressure source may also be configured to control the flow rate. In some embodiments, the system may include a pressure source that employs both positive and negative pressure. In other embodiments, the system may include at least two pressure sources that each employs one kind of pressure. Examples of pressure source may include any known pressure source. The pressure source may include, but is not limited to a pump, such as a syringe pump, displacement pump, peristaltic pump, aspirator, and vacuum pump, and a pipette.

In some embodiments, the system may further include at least one sensing device for measuring parameters of the cells. The sensing device may be configured to detect for a specific biological activity or a variety of biological activities. In further embodiments, the system may further include at least one delivery device for delivering materials to the cells. The sensing and delivery device may be any known device. The devices may be selected and adjusted based on the cells to be sensed/delivered as well as the parameters and materials to be sensed and delivered, respectively.

While the disclosure has been described in detail with reference to exemplary embodiments, those skilled in the art will appreciate that various modifications and substitutions can be made thereto without departing from the spirit and scope of the disclosure as set forth in the appended claims. For example, elements and/or features of different exemplary embodiments may be combined with each other and/or substituted for each other within the scope of this disclosure and appended claims.

What is claimed:

1. A microfluidic device, comprising:
a layer, the layer including a plurality of microvascularized-sized fluidic channels, the plurality of microvascularized-sized fluidic channels being disposed in a geometric pattern; and
the layer being composed of a hydrogel.

2. The microfluidic device according to claim 1, further comprising:
at least another layer, the other layer being composed of the hydrogel.

3. The microfluidic device according to claim 2, wherein the other layer is a base layer, and the layer is disposed above the other layer.

4. The microfluidic device according to claim 2, further comprising:
a top layer composed of silicone elastomer; and
a second layer disposed between the top layer and the layer, the second layer being composed of a gelatin.

5. The microfluidic device according to claim 4, wherein the top layer is composed of polydimethylsiloxane (PDMS), and the top layer is silanized PDSM with amine groups disposed on a surface of the top layer.

6. The microfludidic device according to claim 1, wherein the hydrogel includes a mixture of agarose and gelatin.

7. The microfluidic device according to claim 2, wherein the hydrogel includes a mixture of agarose and gelatin.

8. The microfluidic device according to claim 1, wherein the channels include at least a first channel and a second channel, the first channel having different dimensions than the second channel.

9. The microfluidic device according to claim 8, wherein the first channel has a length that is longer than a length of the second channel.

10. The microfluidic device according to claim 8, wherein the first channel has a width that is larger than a width of the second channel.

11. A microfluidic device, comprising:
at least a first set of at least one microfluidic channel and a second set of at least one microfluidic channel, the first set being configured to have a shear rate that is higher than a shear rate of the second set; and
at least a first subchannel and a second subchannel, the first channel communicating with the first set and the second subchannel communicating with the second set,
wherein the first subchannel has a length that is shorter than a length of the second subchannel.

12. The device according to claim 11, further comprising:
at least a third set of at least one microfluidic channel, the third set being configured to have a shear rate that is between the first set and the second set; and
a third subchannel, the third subchannel having a length that is between the lengths of the first and second subchannels.

13. The device according to claim 11, wherein:
each set includes a plurality of microfluidic channels disposed in parallel; and
the plurality of microfluidic channels of each set merge into respective subchannel.

14. The device according to claim 13, wherein each of the plurality of microfluidic channels of the first set has dimensions that are substantially similar to dimensions of each of the plurality of microfluidic channels of the second set.

15. The device according to claim 11, wherein the first and second subchannels are respectively disposed between the first and second sets and an outlet.

16. The device according to claim 11, further comprising:
at least one layer, the layer includes the microfluidic channels and the subchannels.

17. The device according to claim 16, wherein the layer is composed of a hydrogel.

18. The device according to claim 17, further comprising:
a base layer, the base layer being composed of a hydrogel.

19. The device according to claim 16, wherein the layer is composed of a silicone elastomer.

20. The device according to claim 11, further comprising:
an inlet,
the first set of at least one microfluidic channel and the second set of at least one microfluidic channel being disposed between the inlet and respective subchannel.
